(19) United States
(12) Patent Application Publication
(10) Pub. No.: US 2007/0287368 A1
(43) Pub. Date: Dec. 13, 2007

(54) Skewered shrimp

(75) Inventor: Francois Olivier Rakotonindriana, Majunga (MG)

Correspondence Address: BIRCH STEWART KOLASCH & BIRCH, PO BOX 747, FALLS CHURCH, VA, 22040-0747, US

(73) Assignee: UNIMA EUROPE

(21) Appl. No.: 11/798,271

(22) Filed: May 11, 2007

(30) Foreign Application Priority Data
May 16, 2006 (FR) 06 04354

(51) Int. Cl. A22C 29/02

(52) U.S. Cl. 452/5

(57) ABSTRACT

The skewered shrimp of the invention comprises a stick having at least one shrimp mounted thereon, each shrimp having a shelled central portion defined between a non-shelled head portion and a non-shelled tail portion, wherein the stick is mounted through the head portion and the tail portion of each shrimp in such a manner that the central portion extends to one side of the stick without being pierced by the stick, the shrimps preferably being mounted in pairs, being disposed head-to-tail.

### BACKGROUND OF THE INVENTION

A known skewered shrimp dish that comprises a stick having shrimps mounted thereon, with each shrimp comprising a shelled central portion extending between a non-shelled head portion and a non-shelled tail portion.

In existing skewered shrimp, each shrimp is mounted by passing the stick longitudinally through the entire shrimp, i.e. through the head portion, the central portion, and the tail portion. In order to eat the shrimps after they have been cooked, it is necessary to withdraw the stick by causing the shrimps to slide along the stick so as to be able to cut off the head portion and the tail portion and eat the central portion.

That manipulation is fiddly, particularly when the shrimps are served in restaurants specialized in that type of dish.

Furthermore, the shrimps extend full length along the stick, so it is possible to put only a small number of shrimps on each stick.

### OBJECT OF THE INVENTION

An object of the invention is to propose skewered shrimp presenting a structure that makes it easier to manipulate the shrimps.

### SUMMARY OF THE INVENTION

In order to achieve this object, the invention provides skewered shrimp comprising a stick having at least one shrimp mounted thereon, each shrimp having a shelled central portion defined between a non-shelled head portion and a non-shelled tail portion, wherein the stick is mounted through the head portion and the tail portion of each shrimp in such a manner that the central portion extends to one side of the stick without being pierced by the stick.

Thus, the shelled, central portion can be separated after cooking merely by cutting the shrimp at its boundaries with the head portion and with the tail portion.

In an advantageous version of the invention, the tail portion forms an angle with the stick. This inclination of the tail portion causes the central portion of the shrimp to be arched, and as a result of the shrimp occupies a shorter length of the stick.

In a preferred embodiment of the invention, the shrimps are mounted in pairs, being disposed head-to-tail. This increases the number of shrimps that can be mounted on a single stick.

### BRIEF DESCRIPTION OF THE DRAWING

Other characteristics and advantages invention appear on reading the following description of a particular, nonlimiting embodiment of the invention given with reference to the accompanying figures, in which:

FIG. 1 is a side view of skewered shrimp comprising a single shrimp mounted in accordance with the invention;

FIG. 2 is a side view of skewered shrimp having two shrimps mounted head-to-tail; and

FIG. 3 is a side view of the FIG. 2 skewered shrimp after sectioning shelled central portions.

### DETAILED DESCRIPTION OF THE INVENTION

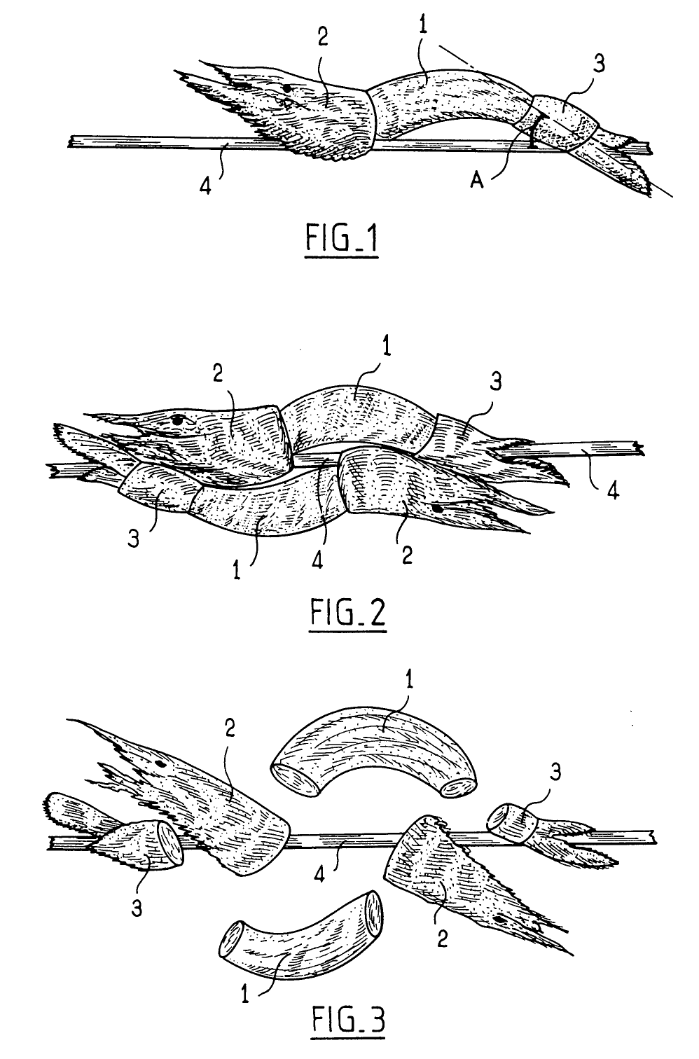

With reference to FIG. 1, the skewered shrimp of the invention is made from shrimps each comprising in conventional manner a shelled central portion 1 extending between a non-shelled head portion 2 and a non-shelled tail portion 3.

According to the invention, the shrimp is mounted on a stick 4 by passing the stick 4 through a portion of the head 2 close to the bottom edge thereof, so that after passing through the head portion, the stick 4 leaves the head portion without passing through the shelled central portion, such that said central portion lies on one side of the stick 4. The stick 4 is then passed through the tail portion 3, preferably while holding the tail portion 3 at an angle A relative to the stick 4 so as to cause the shelled central portion 1 to be arched.

It should be observed that in order to eat the shelled central portion 1 after the shrimp has been cooked, it suffices to cut the shrimp at the ends of the head portion 2 and of the tail portion 3.

FIG. 2 shows a preferred embodiment of the invention that makes it possible both to increase the number of shrimps mounted on a stick and to place them in a pleasing presentation that enables the skewered shrimps to be placed directly on a plate. In this embodiment, the shrimps are mounted in pairs being disposed head-to-tail. For this purpose, the stick 4 is initially passed through the tail portion 3 of a first shrimp, and then through the head portion 2 of a second shrimp, through the head portion 2 of the first shrimp, and finally through the tail portion 3 of the second shrimp. The central portions 1 of the shrimps then extend on either side of the stick 4.

As shown in FIG. 3, when the central portions 1 of the shrimps are eaten, the non-shelled portions remain attached to the stick 4. If the stick 4 is a throwaway sick, then it suffices to discard all that remains in a waste bin. Otherwise, if the stick 4 can be recovered, it should be observed that each non-shelled portion has the stick 4 passing through only a short length thereof, such that the waste can easily be removed from the stick 4.

Naturally, the invention is not limited to the embodiment described, and variant embodiments can be applied thereto without going beyond the ambit of the invention as defined by the claims.

In particular, although the shrimps are shown in the figures as being curved only just enough to enable the shrimps to be mounted head-to-tail, the angle A of the tail portion 3 relative to the stick 4 can be increased so that the central portion 1 is then curved more strongly and each shrimp occupies even less space along the length of the stick 4.

Although, in the preferred embodiment, the shrimps are grouped together in pairs and mounted head-to-tail, the shrimps could be mounted in other dispositions, for example they could be grouped together in threes, two shrimps then being disposed tail-to-tail on one side of the stick, while the third shrimp is mounted astride the adjacent tail portions with its central portion extending on the opposite side of the stick. Skewered shrimp can also include only a single shrimp.

What is claimed is:

1. Skewered shrimp comprising a stick having at least one shrimp mounted thereon, each shrimp having a shelled central portion defined between a non-shelled head portion and a non-shelled tail portion, wherein the stick is mounted through the head portion and the tail portion of each shrimp in such a manner that the central portion extends to one side of the stick without being pierced by the stick.

2. Skewered shrimp according to claim 1, wherein the tail portion forms an angle with the stick.

3. Skewered shrimp according to claim 1, comprising a plurality of shrimps mounted in pairs and disposed head-to-tail.
